(19) United States
(12) Patent Application Publication
(10) Pub. No.: US 2008/0068356 A1
(43) Pub. Date: Mar. 20, 2008

(54) METHOD AND APPARATUS FOR DELIVERING AND DISPLAYING MULTIMEDIA CONTENT TO FOOD SERVICE CUSTOMERS

(76) Inventors: Aleksandrs Zavoronkovs, Kingston (CA); Roman Kyrychynskyi, Toronto (CA)

Correspondence Address: BERESKIN AND PARR, 40 KING STREET WEST, BOX 401, TORONTO, ON, M5H 3Y2, US

(21) Appl. No.: 11/533,584

(22) Filed: Sep. 20, 2006

(51) Int. Cl. G09G 5/00

(52) U.S. Cl. 345/204

(57) ABSTRACT

A display tray apparatus, a system and a method for displaying multimedia content to customers of food service establishments. The display tray apparatus consists of a food serving tray having a rigid plate portion, and a display apparatus embedded in the plate portion. The display apparatus includes a display screen, a network interface for communicating with a server containing multimedia content, and a display controller for controlling the display screen and network interface. The food serving tray includes a top cover sheet covering the plate portion and display screen, and a bottom cover sheet covering its bottom surface. The cover sheets protect the display apparatus from harm during use and washing. The system includes a content server, a communications network, and a plurality of display trays capable of receiving multimedia content from the content server through the network. The method includes the steps of providing multimedia content on the content server; providing to customers a plurality of display trays; transferring the multimedia content from the server through the network to the display trays; and displaying the multimedia to the customers through the display screen of the display trays.

### FIELD OF THE INVENTION

The present invention relates to methods and apparatus for delivering and displaying multimedia content, such as advertising or promotional information, to customers of food service establishments such as food courts and fast food restaurants.

### BACKGROUND OF THE INVENTION

Dining at fast food restaurants and food courts has become popular over the past several decades. Reusable plastic food serving trays are common in such places. These trays vary in size, shape, form, color, material and design, but generally have rectangular or oval form and are usually 7″ to 15″ by 9″ to 20″ in size. Some trays have one or more compartments for various food items or cup, bottle or cutlery compartments or holders.

Some restaurants imprint their marketing information on the tray, but most restaurants cover the tray with a paper or plastic cover sheet before placing food on the tray. Marketing, promotional or advertising materials of the restaurant or restaurant partners, or personalized information of interest to specific customer groups may be printed on the cover sheets. However, this approach allows only one set of marketing materials to be presented to the user during his time using the tray, and there is no way to accept any input from the user or to interact with him.

Another challenge of fast food restaurants is to make customers' experience more enjoyable and to encourage the customer to make follow up purchases. To this end, some restaurants feature in-store displays delivering various content to the customers and some restaurants provide on-site personal computers (PC) enabling customers to access the Internet. Unfortunately, not all customers may be close to an in-store display or able to view it from a comfortable angle. PCs are difficult to use while eating and are expensive to provide to every table, let alone every customer.

Accordingly there is a need for a method of delivering to customers advertising and promotional content which is not static and inanimate. There is also a need for a system that inexpensively delivers such content to each customer individually.

### SUMMARY OF THE INVENTION

The present invention is directed to a display tray apparatus for displaying multimedia content to customers of food service establishments. The display tray apparatus comprises a food serving tray comprising a rigid plate portion having a top surface shaped for carrying food, and a display apparatus embedded in the plate portion. The display apparatus comprises a user viewable display screen, a network interface for communicating with a remote server containing multimedia content, and a display controller for controlling the display screen and the network interface.

The food serving tray may comprise a raised edge portion surrounding the plate portion. The plate portion may include a cut-out shaped for receiving the display screen, and a bottom surface having at least one recess shaped for receiving components of the display apparatus. The food serving tray preferably comprises a top cover sheet for covering the plate portion and the display screen, the top cover portion having a transparent portion located to overlay the display screen, and a bottom cover sheet for covering the bottom surface of the plate portion and protecting the components of the display apparatus. The display apparatus may comprise a user input module operatively coupled to the display controller, the user input module enabling a user to interact with the display screen and the remote server.

The present invention is also directed to a system for delivery of multimedia content to customers of food service establishments. The system comprises a multimedia content server which comprises a computer server having multimedia content stored in a content database and a server network interface; a communications network connected to the content server and the server network interface; and a plurality of display trays comprising a food serving tray having a rigid plate portion, and a display apparatus, wherein the display apparatus comprises a display screen, a display controller, and a client network interface capable of connecting to the communications network and receiving multimedia content from the content server.

The system may further include one or more tray racks for washing and recharging the display trays. The tray racks comprise a frame having at least one frame section, the frame section comprising a first horizontally extending support member, a second horizontally extending support member spaced therefrom, and vertical members extending between the first support member and the second support member; the first support member having an upper surface with a plurality of longitudinally spaced, transversely extending first tray slots therein, and the second support member having a bottom surface with a plurality of longitudinally spaced, transversely extending second tray slots therein, the tray slots in the first and second support members being located so as to form a series of vertically aligned pairs of tray slots, the slots being shaped so as to receive the top flange of the raised edge portion of one of the display trays, the support members being spaced apart so that one of the display trays may be placed on edge and slid into each of the aligned pairs of tray slots; and a plurality of transversely extending charging rails affixed to the support members adjacent the tray slots, the charging rails being located to contact the recharging rails when the display trays are slid into the aligned pairs of tray slots.

The tray racks may comprise a rack network interface connectable to the communications network, allowing the tray rack to be in communication with the content server, and plurality of port connectors, wherein the rack port connectors are shaped to connect to I/O port connectors of the display trays so that multimedia content can be communicated to the display trays. The I/O port connectors may also be connected to user devices so that multimedia content can be communicated from the display trays to the user devices.

The present invention is further directed to a method for delivering multimedia content to a customer of a food service establishment. The method comprises the steps of loading multimedia content on to a content server, the server comprising a computer server having a multimedia content database and a server network interface connected to a network; transferring multimedia content from the server through the network to one or more display trays, the display trays comprising a food serving tray having a food carrying portion, a rim portion extending upwardly around the food carrying portion, and a display apparatus, wherein the display apparatus comprises a screen, a user input module, a display controller, and a client network interface capable of connection to the network; storing a portion of the multimedia content to a memory in the display controller; providing food to a customer of a food service establishment on the display tray; and showing the multimedia content to the customer through the screen of the display tray.

### BRIEF DESCRIPTION OF THE DRAWINGS

The invention will now be described, by way of example only, with reference to the following drawings, in which;

FIG. 1 is a block diagram of a wireless multimedia content delivery system made in accordance with the invention;

FIG. 2 is a perspective view of a display tray made in accordance with the preferred embodiment of the invention;

FIG. 3 is a top plan view of the display tray made in accordance with the preferred embodiment of the invention;

FIG. 3A is a partially exploded view of the display tray, wherein the plate portion has been cut away along line 3A-3A in FIG. 3;

FIG. 3B is a sectional view of the display tray, taken along line 3A-3A in FIG. 3;

FIG. 4 is an exploded perspective view of the display tray;

FIG. 5 is a perspective view of the display tray as viewed from the bottom;

FIG. 6 is a side elevational view of the display tray;

FIG. 7 is a block diagram of a display tray controller used in the present invention;

FIG. 8 is a view of a display tray rack made in accordance with a preferred embodiment of the invention, shown holding several display trays; and

FIG. 9 is a block diagram of a wired multimedia content delivery system made in accordance with an alternative embodiment of the invention;

FIG. 10 is a flow chart of a method of delivering multimedia content to customers of food service establishments; and

FIG. 11 is a detail flow chart further illustrating particular steps of a method of delivering multimedia content to customers of food service establishments.

### DETAILED DESCRIPTION OF THE INVENTION

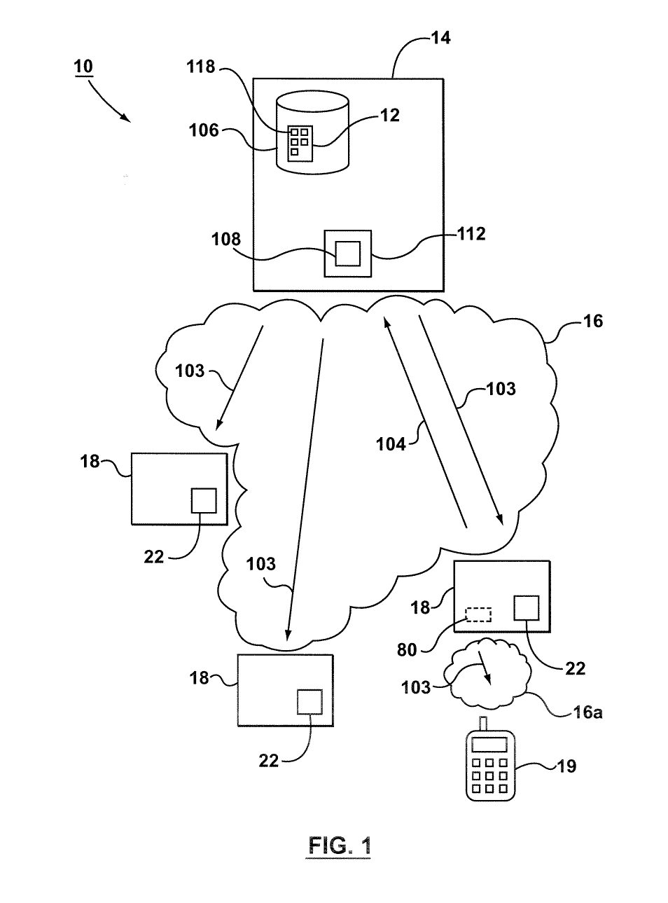

Referring to FIG. 1, illustrated therein is a system 10 for delivering multimedia content 12 to customers of food service establishments in accordance with a preferred embodiment of the invention. Delivery system 10 comprises a multimedia content server 14, a communications network 16, and a plurality of display trays 18. Content server 14 stores multimedia content 12 and transfers it to one or more display trays 18 over communications network 16 encapsulated in network data packets 103. Display trays 18 then show multimedia content 12 to the customers. Multimedia content 12 may include video, still images, text or computer instructions in any combination, and in some embodiments, may include audio as well. In an alternative embodiment, display tray 18 may also be connected to an optional user device 19 through a low power, or local network or communications link 16a.

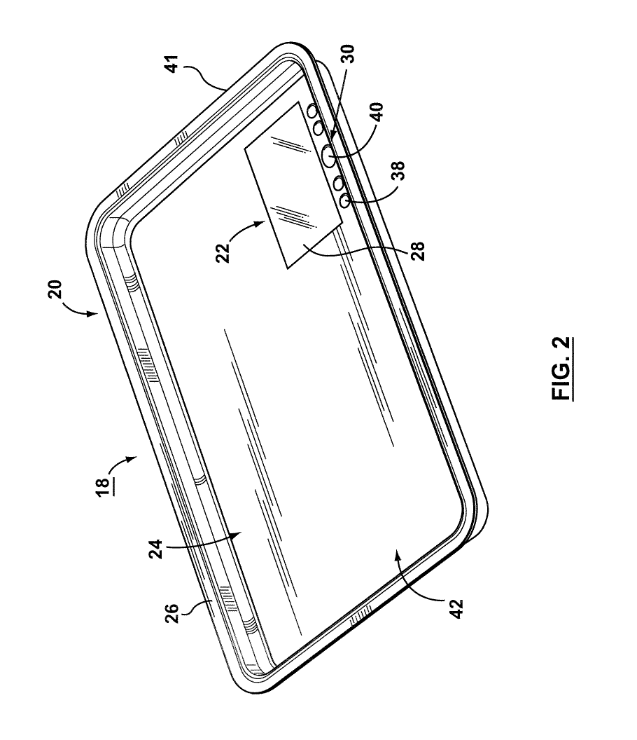

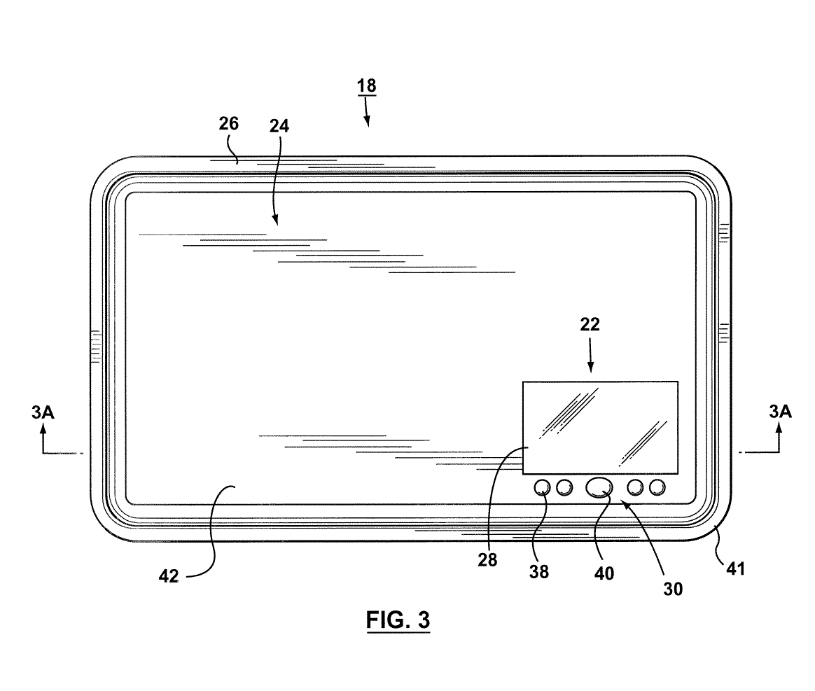

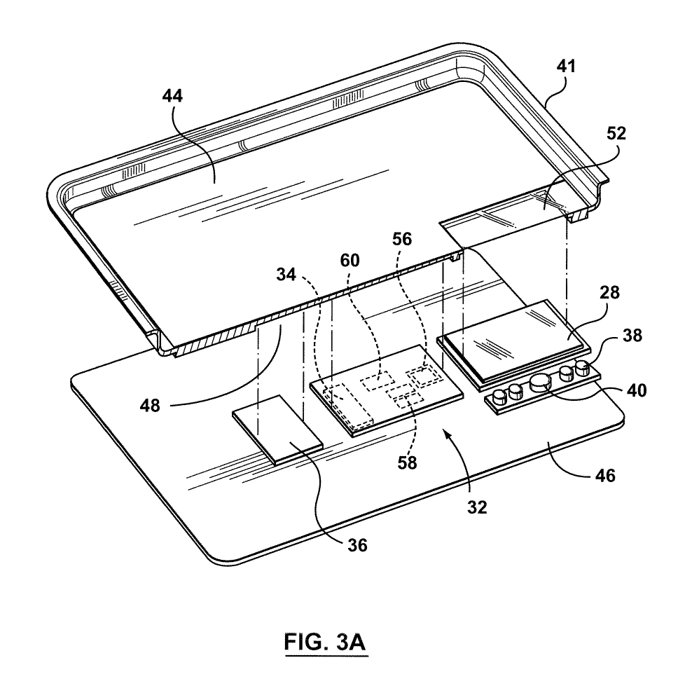

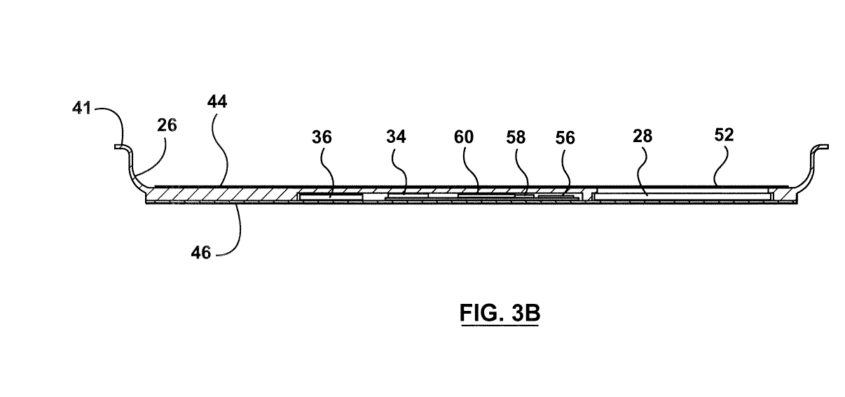

Referring now to FIGS. 2 and 3, illustrated therein is a display tray 18 made in accordance with a preferred embodiment of the invention. Display tray 18 comprises a food serving tray 20 having display apparatus shown generally as 22 embedded therein. Food serving tray 20 comprises a rigid plate portion 24 having a top surface 42 shaped for carrying food, and a raised edge portion 26 surrounding plate portion 24, which prevents food items from sliding off the side of the tray. Raised edge portion 26 may comprise a top flange 41 extending horizontally therefrom. As shown, top surface 42 of plate portion 24 is generally flat, although top surface 42 could include ridges separating plate portion 24 into food compartments.

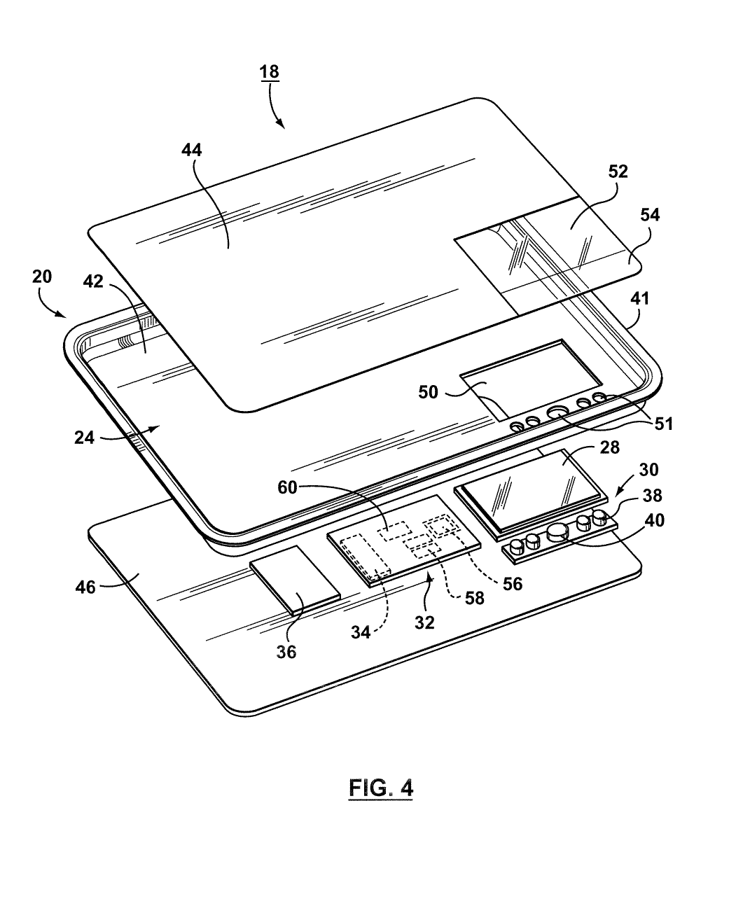

Referring now to FIGS. 3A, 3B, 4 and 5, display apparatus 22 comprises display screen 28, user input module shown generally as 30, display controller shown generally as 32, and network interface 34 adapted to receive multimedia content 12 from content server 14 over network 16. In the preferred embodiment, user input module 30 comprises four buttons 38 and a directional joystick 40.

Plate portion 24 is preferably constructed of a lightweight, inert material such as plastic or fibreglass. Plate portion 24 has a rectangular cut-out 50 that exposes screen 28 to the user and circular cut-outs 51 shaped to expose buttons 38 and joystick 40. As shown in FIG. 3B, the bottom surface of plate portion 24 has recesses 48 molded or formed therein that are shaped to receive display apparatus 22. The top surface of display screen 28 preferably fits flush with the top surface of plate portion 24. The main body of display screen 28 is slightly larger than cut-out 50 and butts against the inner surface of recess 48 so that display screen 28 cannot pass through cut-out 50. Similarly, buttons 38 and joystick 40 are exposed through cut-outs 51, but because buttons 38 and joystick 40 are mounted on one or more circuit boards the circuit boards larger than cut-outs 51, they also cannot pass through cut-out 51 and are held securely in recess 48.

To protect display apparatus 22 from vibration, and to prevent display tray 18 from rattling because of the loose placement of display apparatus 22 inside recesses 48, a filler material, such as strips of foam rubber, is used to pack the left over space between display apparatus 22 and recesses 48.

Plate portion 24 preferably comprises top cover sheet 44 and bottom cover sheet 46. Top cover sheet 44 and bottom cover sheet 46 allow display tray 18 to be washed without harm to display apparatus 22.

Top cover sheet 44 is preferably a sheet of material such as plastic, and is shaped to overlay top surface 42 of plate portion 24. Top cover sheet 44 is bonded to plate portion 24 by an adhesive such as epoxy or glue. In alternative embodiments, top cover sheet 44 may be bonded to plate portion 24 by a thermosetting process. Top cover sheet 44 should be resistant to heat, humidity, liquids, and cleaning agents such as dishwashing soap in order to protect display apparatus 22.

Top cover sheet 44 may include viewport 52 sized to overlay at least screen 28, allowing the user to view the picture displayed therein. Top cover sheet 44 may include a resilient portion 54 covering buttons 38 and joystick 40 of user input module 30, allowing the user to interact with display tray 18 but still providing environmental protection for display apparatus 22. Top cover sheet 44 must cover at least screen 28 and user input module 30, but otherwise may be any size up to the size of plate portion 24. Viewport 52 may be larger than display screen 28, and top cover sheet 44 may be entirely transparent. Ideally, in order to maintain good visibility of screen 28, viewport 52 should be difficult to scratch under normal restaurant use.

Bottom cover sheet 46 is preferably bonded to plate portion 24 using adhesive, and seals display apparatus 22 and plate portion 24 from the environment. Bottom cover sheet 46 contacts display apparatus 22 or the filler material and holds display apparatus 22 firmly in recesses 48. Bottom cover sheet 46 is preferably opaque, and thicker than top cover sheet 44.

Display screen 28 is preferably a liquid crystal display (LCD), although screen 28 alternatively comprises any other type of low power video displays, including plasma, light emitting diode (LED), organic LED (OLED), or electronic ink displays. In some embodiments, screen 28 may be back lit or side lit, but in still others, screen 28 may rely on ambient lighting or on the emission of light from the screen itself, depending on the technology used. If the primary multimedia content is video or still graphical images with substantially bold as opposed to fine elements, it may be possible to use display technology of lower quality and cost than that used for other typical small screen displays which must show clear and legible text to the user, such as those used in personal digital assistants (PDA) or mobile phones.

User input module 30 may comprise four buttons 38 activated by microswitches, and a directional joystick 40. In alternative embodiments, user input module 30 could instead comprise switches, wheels, controls, touchable areas, or any finger operable device suitable for interaction with display tray 18. In particular, user input module 30 could comprise a touch sensitive portion of display screen 28.

Display screen 28 is preferably located in the lower right corner of display tray 18. However, it should be understood that screen 28 may be located anywhere within the surface of plate portion 24, and may be any size smaller than plate portion 24. User input module 30 may likewise be located anywhere within plate portion 24. User input module 30 may be implemented as on-screen controls using touch screen technology, in which case user input module 30 and screen 28 may overlap.

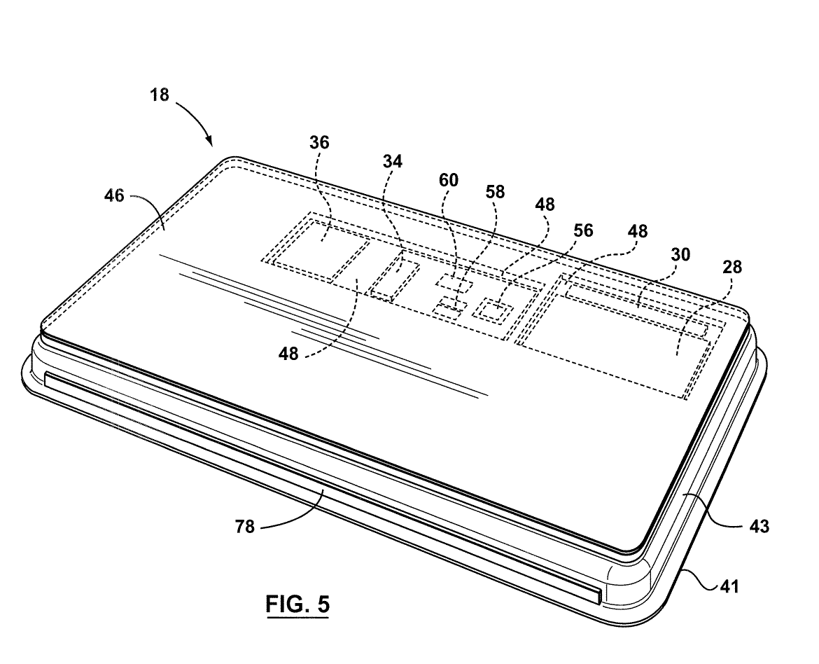

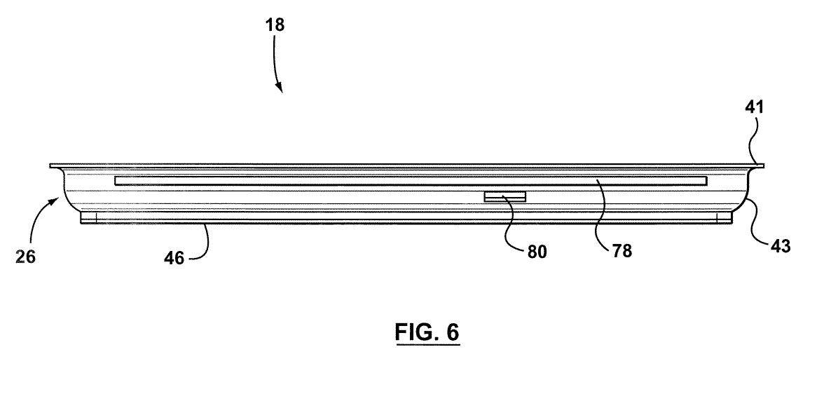

As shown in FIGS. 5 and 6, display tray 18 may include one or more recharging rails 78 extending outwardly from outside surface 43 of raised edge portion 26. Alternatively, recharging rails 78 may be embedded inside display tray 18 without being exposed to the external environment, for example, within raised edge portion 26 or within plate portion 24. In such a case, contactless charging, such as induction charging, could be used to recharge rechargeable battery 36.

Display tray 18 may also include an input/output (I/O) port 80, whose physical interface is exposed on the outside of raised edge portion 26. I/O port 80 may be based on standard or proprietary hardware or wireless communication means, including infrared, Bluetooth, mesh network, universal serial bus (USB), mini USB and so on. In an alternative embodiment, I/O port 80 may be used by display tray 18 to communicate, as shown in FIG. 1, with a user device 19, through a local network 16a, in order to further transfer multimedia content 12 to user device 19. Examples of suitable user devices include mobile phones, personal digital assistants (PDA), digital audio players, ultra-mobile personal computers (UMPC) and laptop computers, electronic book or e-book readers and so on.

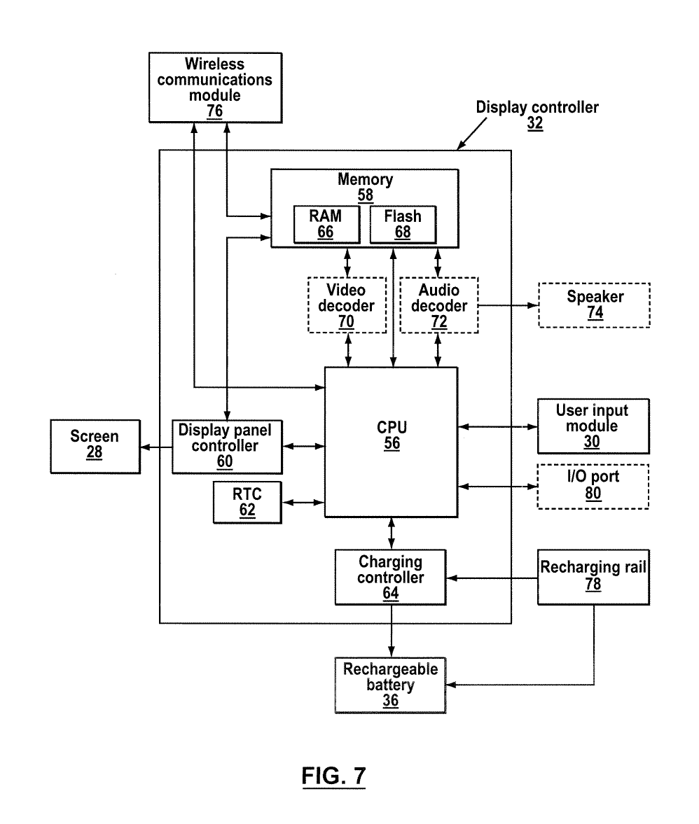

Referring to FIGS. 5 and 7, display controller 32 is preferably a commercially available microcontroller comprising a central processing unit (CPU) 56, memory 58, display panel controller 60, real-time clock (RTC) 62 and charging controller 64. Memory 58 comprises both volatile and non-volatile portions. For example, memory 58 may comprise volatile RAM 66, and non-volatile flash memory 68. Display controller 32 may optionally comprise video decoder 70 and may also optionally comprise audio decoder 72 and speaker 74. It should be understood that, in alternative embodiments, any of the elements comprising display controller 32 may be broken out into discrete, stand alone components.

Inside display controller 32, CPU 56 is operatively coupled to memory 58, to display panel controller 60, to RTC 62, and to charging controller 64, as well as to video decoder 70 and audio decoder 72 if they are available. CPU 56 is also operatively coupled to user input module 28 and to I/O port 76 from outside of display controller 32.

When data packets 103 are received by network interface 34, which preferably comprises a wireless communications module 76, they are stored by network interface 34 directly into memory 58 using direct memory access (DMA) without intervention from CPU 56. In alternative embodiments, CPU 56 may itself copy multimedia content 12 from network interface 34 to memory 58.

CPU 56 runs computer instructions from memory 58 which may be permanently stored in a non-volatile portion, or which may have been received through wireless communications module 76 and stored in either volatile or non-volatile memory. The computer instructions cause CPU 56 to output a video signal to display panel controller 60 which in turn causes a picture to be displayed on screen 28. Display panel controller 60 converts a digital representation of picture data stored in memory 58 (e.g. a framebuffer) into a video signal representable on screen 28 as a picture.

RTC 62 provides a time signal to CPU 56. In the case where the currently displayed multimedia content 12 is video, CPU 56 uses this time signal to decide when the next frame of video should be output through display panel controller 60 to screen 28 for the user to view. Similarly, when the currently displayed multimedia content 12 is a still image, CPU 56 uses the time signal to decide when the next still image should be output.

When a user activates a user interface element of user input module 30, a signal is sent to CPU 56 which may react to the input depending on the current state of displayed material.

If available, video decoder 70 is used to decode video data stored in memory 58 or video streams received through wireless communications module 76, saving CPU processing and hence lowering overall power consumption. Similarly, if an audio decoder 72 is available, it may be used to decode audio data or audio streams and output audio to speaker 74.

Charging controller 64 detects when display apparatus 22 is connected to a source of electrical energy and notifies CPU 56. Charging controller 64 is capable of regulating and opening or closing a connection between recharging rail 78 and rechargeable battery 36. CPU 56 controls the charging process through charging controller 64 to ensure that rechargeable battery 36 is not charged too quickly and is not over charged.

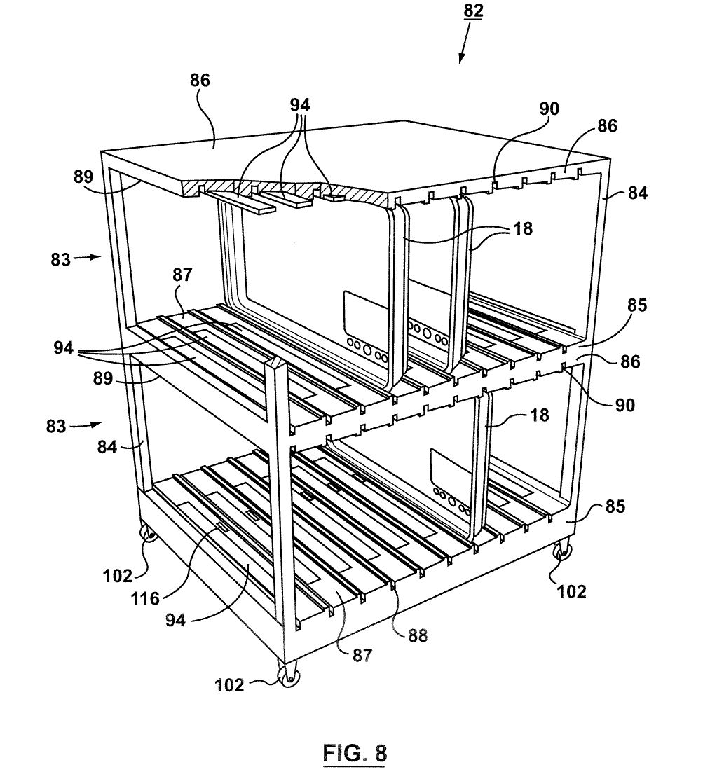

Referring now to FIG. 8, the system of the present invention may also include a tray rack 82 for washing and recharging display trays 18. Tray rack 82 comprises a frame having at least one frame section 83. If there is more than one frame section 83, the sections are preferably vertically stacked.

A frame section 83 comprises a first horizontally extending support member 85 and a second horizontally extending support member 86 spaced apart from it. Vertical members 84 extend between first support member 85 and second support member 86. First support member 85 and second support member 86 are preferably made from a rigid plastic.

Upper surface 87 of first support member 85 has a plurality of longitudinally spaced, transversely extending tray slots 88 formed therein. Similarly, bottom surface 89 of second support member 86 also has a plurality of longitudinally spaced, transversely extending tray slots 90 formed therein. Tray slots 88 and tray slots 90 are located to form vertically aligned pairs and are shaped to receive top flange 41 of raised edge portion 26 of a display tray 18. First support member 85 and second support member 86 are spaced to receive a display tray 18 which has been placed on edge and slid into an aligned pair of tray slots 88 and 90.

Charging rails 94 extend transversely along the space in between adjacent tray slots 88 and 90, and are exposed to touch recharging rails 78 directly. In an alternative embodiment of the invention where contactless charging is used, charging rails 94 may be sealed from the environment.

Tray rack 82 is adapted to fit into a dish washing apparatus or other means of washing display trays 18. In alternative embodiments, tray rack 82 may itself directly include water spouts and other washing apparatus for cleaning the surfaces of display tray 18. In FIG. 8, display trays 18 are slotted into tray rack 82 along the vertical plane, to facilitate water and waste runoff, but they may also be slotted into tray rack 82 along the horizontal plane in cases where, for example, food and waste have not yet been dumped or removed from tray 18 before it is returned by the user. Tray rack 82 may optionally include swivel wheels 102 attached to the underside of bottommost first support member 85 allowing tray rack 82 to be conveniently transported throughout a food court or restaurant to pick up display trays 18 no longer in use by customers.

Referring again to FIGS. 1 and 7, for low levels of interactivity, display tray 18 may respond to user input solely according to instructions contained in interactive multimedia content 12. However, for high levels of interactivity, or where the user may request content which it would not be economical to store in memory 58, because of the size of the content or the breadth of choices available, wireless communications module 76 may support two way communication and allow return data packets 104 to be sent from display tray 18 back to content server 14.

Multimedia content server 14 is preferably a computer server having a multimedia content database 106 which in turn may comprise any computer storage means such as disk or memory. Additionally, multimedia content server 14 further comprises a server network interface 112, which preferably comprises a wireless basestation 108, to communicate with display tray 18 over network 16. In the preferred embodiment, content server 14 is also connected to the Internet.

Multimedia content 12 may comprise a plurality of programs 118. Programs 118 in turn may comprise video audio still graphical images, computer instructions, time indices, or any combination of the above. In the preferred embodiment, each program 118 corresponds to one advertisement or to an integrated user activity such as an interactive menu or a web browsing session.

The time index of a program 118 may indicate to display controller 32 when to start displaying the video or still image contents of program 118 if no user interaction has occurred within a certain time limit.

The computer instructions of program 118 may instruct display controller how to order or interleave video and still image content and how to interact with the user. Programs 118 may comprise an entire video clip transferred to display tray 18 and stored in memory 58, but in alternative embodiments of the invention, program 118 may contain computer instructions and a reference to a video stream instead. In this case, display tray initiates streaming from content server 14 and decodes video on the fly from streamed data instead of decoding a complete video clip stored in memory 58.

An example of the format programs 118 could take is an Adobe Flash, or SWF, file which includes support for vector and raster graphics, a scripting language and streaming of audio and video.

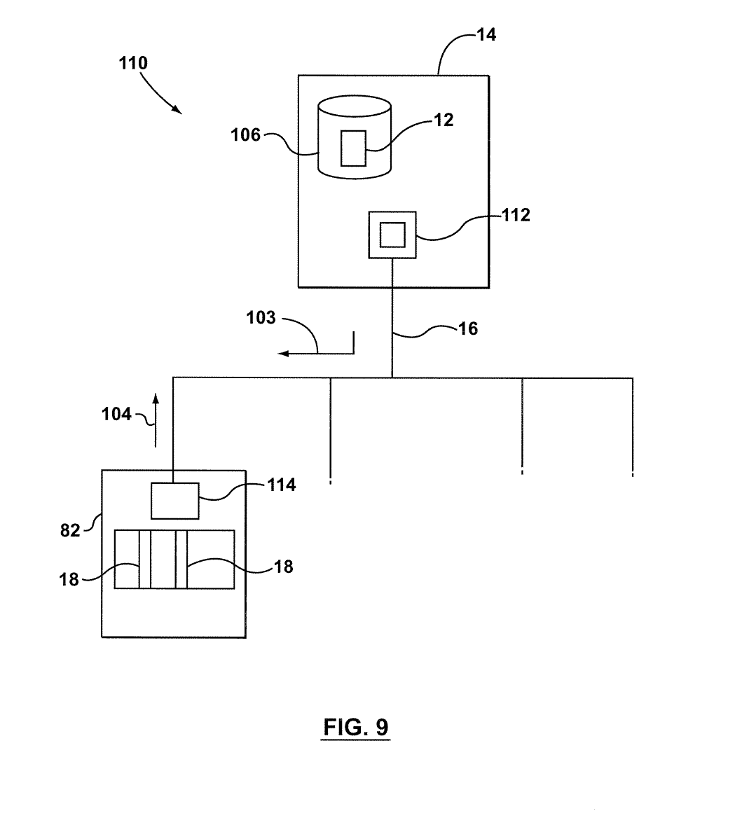

Referring now to FIG. 9, in an alternative embodiment of the invention, wired multimedia content distribution system 110 may comprise a wired communications network 16, which links multimedia content server 14 with a number of tray racks 82.

In this embodiment, tray racks 82 further comprise a network interface 114 connected to network 16 and allowing tray racks 82 to connect to content server 14. Tray rack port connector 116 is adapted to mate and connect with I/O port 80 on display tray 18. Multimedia content 12 is transferred from tray rack 82 to display tray 18 through this connection. The connection between rack port connector 116 and I/O port 80 may be through contact, as in typical physical electrical connectors, or may be contactless as through induction or low power radio frequency (RF) activated by proximity of display tray 18.

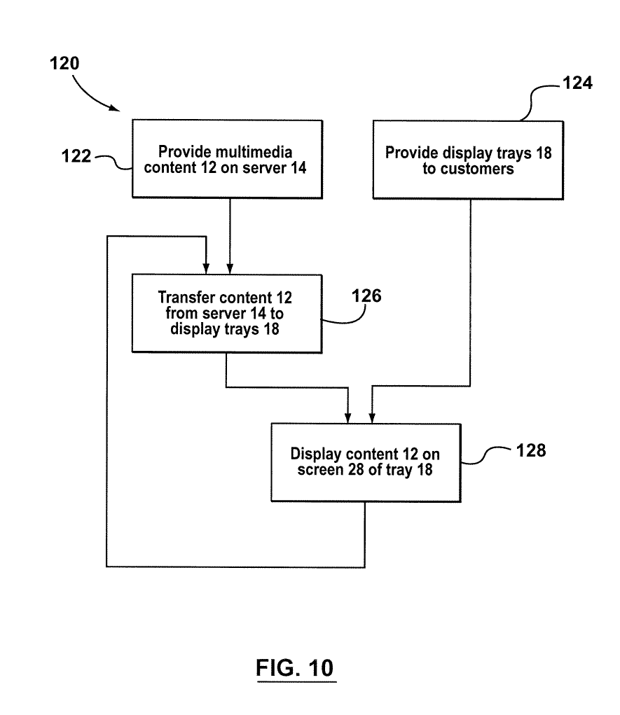

FIG. 10 illustrates a method 120 of distributing multimedia content to customers of food service establishments. The following use case illustrates a preferred embodiment of method 120.

In step 122, the operator loads multimedia content 12, comprising at least one program 118, on to content server 14 for later delivery to display trays 18. The operator can select a series of programs 118 from multimedia content database 106 to be queued for delivery at a pre-selected time period. The operator also selects a time period when non-interactive programs 118 such as video or still image slideshows should be displayed.

Once programs 118 have been loaded into multimedia content database 106, they can be encapsulated and transferred as multimedia content 12 to display tray 18 for eventual display. In step 126, programs 118 are sent wirelessly to display tray 18 which receives them using wireless communications module 76.

Asynchronously to steps 122 and 126, in step 124 a display tray 18 is provided to a customer, with his food order placed upon plate portion 24. After sitting down and placing display tray 18 on a table top or other suitable eating surface, the user may watch or interact with display tray 18 while eating, as multimedia content is shown to him in step 128.

For example, display tray 18 may show a slideshow of still graphical advertisements, or it may show a series of video advertisements. It is also possible for display tray 18 to include interactive content, such as quizzes or puzzles or games related to nearby stores or restaurants. If desired, on answering a quiz or solving a puzzle correctly, display tray 18 could display a prize coupon redeemable at a store or restaurant.

If user interaction results in a request for more or different content, the method may return to step 126 to transfer new content to the tray. This also happens when certain other triggers are detected. In the preferred embodiment of the invention one such trigger is a scheduled content download time. In other embodiments, it may be when the content currently stored in display tray 18 has played for a predetermined number of cycles.

Steps 126 and 128 may also be performed simultaneously. That is, display tray 18 is capable of showing stored multimedia content 12 to the user while at the same time receiving new multimedia content 12 through network 16.

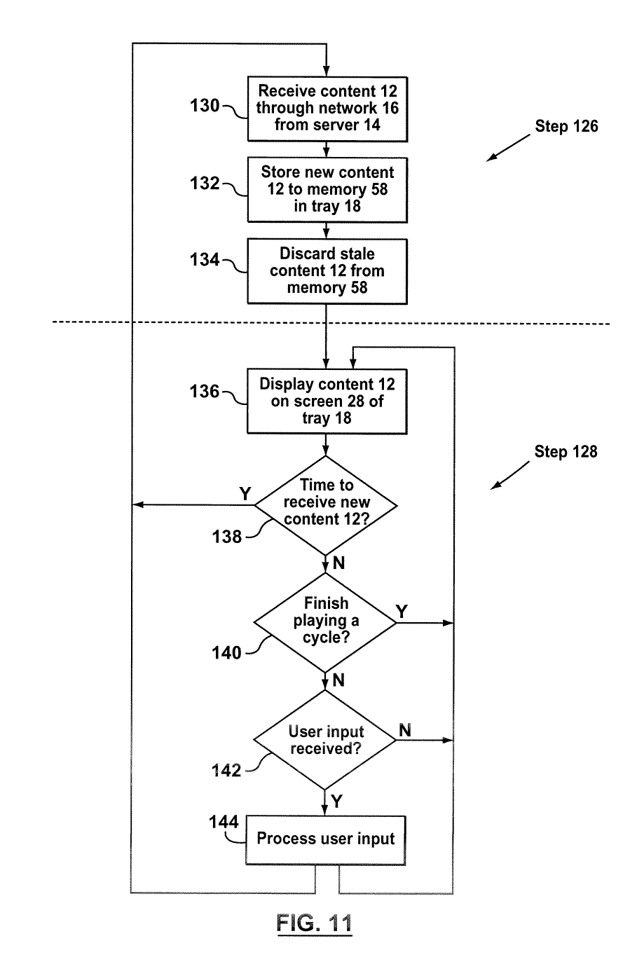

FIG. 11 illustrates steps 126 and 128 in further detail. In step 130, current multimedia content 12 is received by wireless communication module 76 of display tray 18. In step 132, current content 12 is stored to memory 58 by wireless communications module 76.

Programs 118 may be kept in memory 58 on a first in first out (FIFO) basis if there is not enough room to store them all. Other program replacement algorithms may also be chosen if desired.

In step 134, display tray 18 periodically checks whether any of its stored multimedia content 12 is stale. That is, it compares the time period in which multimedia content 12 is to be displayed with the current time obtained from RTC 62 or from a time signal obtained over the network. If the current time is greater than the expiry time of multimedia content 12, the stale content 12 is discarded from memory 58.

Next, in step 136, stored programs 118 are decoded and displayed on screen 28. While programs 118 are being displayed, certain events may cause CPU 56 to take action other than only displaying programs 118.

For instance, in step 138 when RTC 62 indicates that it is time to receive a new batch of programs 118 from content server 14, CPU 56 may return to step 130. Note that steps 130 and 136 may be performed simultaneously.

In step 140, after each program 118 has finished, CPU 56 determines whether it was the last program in the current batch. If so, CPU returns to step 136 and starts displaying programs 118 again from the beginning. In some embodiments, programs 118 may each be played in different or random order, or may be played with different frequency in a cycle. For example, some short advertisements, or advertisements whose sponsors paid a higher fee, might be shown with greater frequency.

In step 142, if CPU 56 detects that input has been received through user input module 30, it will proceed to step 144, otherwise, it will continue playing content 12 in step 136.

When user input has been received, it is processed in step 144. Examples of user input are to increase or decrease brightness or volume, to skip forward to the next program or rewind to the previous program.

If a higher level of interactivity is desired, there may be a menu system whereby the user is allowed to choose the type of activity in which he wishes to partake. Examples of such activities might be to watch previews or trailers for movies now playing, or to request weather or traffic bulletins. A store directory may be stored in display tray 18 and made accessible or searchable by the user. Nutritional information regarding food choices available might also be selectable. For display trays 18 including wireless communications module 72 with two way communications capability, it is also possible that users could order items and products from nearby stores for delivery to the tray's location. CPU 56 would send such a request to content server 14 in a user message sent as return data packets 104 through communications network 16 and then return to step 130 to receive the new content.

In an alternative embodiment, some or all of multimedia content 12 may be offered for sale. The user browses the desired multimedia content 12 using user input module 30. CPU 56 responds to the user input by listing the available content. This listing could take the form of small thumbnail images to represent still images or video. Previews of the available content may be made available to the user. For example, short video and audio clips may provide a preview of video or music, or a short excerpt of text may preview an e-book. The user then selects the desired multimedia content 12, again using user input module 30. After the multimedia content 12 has been chosen, CPU 56 sends a request for the content and the needed purchase information to content server 14, and then returns to step 130 to receive the purchased multimedia content 12 followed by displaying it to the user in step 136.

The purchased multimedia content may include mobile phone ringtones and wallpaper, digital music, video clips, electronic books or e-books, computer software and games, and so on for use on a user device 19. Once multimedia content 12 has been selected for purchase, a user message sent as return data packets 104 containing purchase information is sent to content server 14 requesting it. Content server 14 sends multimedia content 12 to display tray 18 which in turn transfers it to user device 19 through I/O port 80 and local network 16a.

The provision by the present invention of multimedia information and entertainment, such as news, cartoons, jokes, movie previews, recipes & nutrition information, weather forecasts and so on, increases customer satisfaction and enhances the dining experience, especially for lone diners. The invention increases customer loyalty and encourages more frequent repeat visits.

The present invention also allows restaurant owners, food-court operators, or other parties maintaining food trays to increase revenue by running targeted promotions for in store or food court purchases (e.g. purchase desert for ½ price at . . . ), in-mall advertising specials (e.g. Shoes are on sale at . . . ), or by broadcasting third party ads (e.g. Always by Coca-cola).

The system of the present invention could be configured to enable the operator to allow sharing of multimedia content 12 between display trays 18. A first, sharing, display controller 32 of a first display tray 18 publishes a list of shareable multimedia content to content server 14. Other display controllers 32 of display trays 18 in system 10 are configured to access this list of shareable multimedia content and to request desired content from content server 14. Content server 14 is then configured to retrieve the desired content 12, or authorization for sharing such content, from the first, sharing display controller 32 and to communicate the requested content 12 or authorization to the second, requesting display controller 32. The source of the multimedia content 12 shared by first display controller 32 could be a user device 19 connected by local network or communications link 16a with display controller 32, or could be the multimedia content 12 stored in or accessible through, with authorization, a user's network account.

In the case where multimedia content 12 comes from a user device 19, sharing display controller 32 queries user device 19 to discover what multimedia content 12 is available for sharing and sends a list of shared content with a unique identifier to content server 14 in return data packets 104. Other display controllers 32 of other display trays 18, when running an appropriate program 118, may obtain this list from content server 14 for display to requesting users. If a requesting user chooses to view or hear the shared content, his requesting display controller 32 sends a request to content server 14 which uses the unique identifier associated with the shared content to determine which display controller 32 is sharing it and to make a request to stream or transfer that shared content. The content server 14 then forwards the streamed or transferred content to the requesting display controller 32.

In another embodiment, the display controllers 32 may share multimedia content between themselves, peer-to-peer, without the need for a centralized directory in content server 14. The display controllers 32 are made discoverable, using network technology such as Bonjour, and may themselves locate other display controllers 32 connected to network 16 which are offering network services such as content sharing, and thus share multimedia content between themselves directly, without passing through content server 14.

The system of the present invention could also be configured to allow some forms of multimedia content, such as e-books and music, to be transferred to, or made available from, a network account, instead of being purchased for immediate use. The network account may be provided on content server 104, on a centralized server, or on the server of a partnering company. For example, once a video is purchased, it may be listed in a “library” associated with the user, who is then able to download the video from the library at a later time to a device such as a personal computer for viewing, or to view it in streaming form from any web browser.

The system of the present invention could also be configured to provide on-line or network gaming between users. A first player operates a first display controller of a first display tray. The first player plays with or against at least one opponent, his opponent operating a second display controller of a second display tray. Both of the display controllers are in communication with content server 14 which maintains game state and keeps score. In some embodiments, a web or Internet based interface is added so that Internet users can also communicate with content server 14 and participate in such games. Preferably, the games for Internet participants are implemented using an applet downloadable and executable by a web browser on a PC.

Although FIGS. 1 and 9 depict a wireless system 10 and a wired system 110 respectively, any combination of wired and wireless display trays 18 and racks could be used within a single system. For example, any number of racks may be wired to multimedia content server 14 and any number of racks may instead be connected to multimedia content server 14 wirelessly. Furthermore, any number of display trays 18 may receive multimedia content 12 wirelessly, while other display trays 18 receive multimedia content 12 by docking in a tray rack 82 and receiving it through I/O port 80.

In an alternative embodiment, recharging rails 78 may be replaced by a set of solar cells protected by a transparent portion of too cover sheet 44.

While the preferred embodiment comprises a rechargeable battery 36, it should be understood that any other means for storing electrical energy, whether chemical or other, could be used instead.

It should therefore be apparent to one skilled in the art that various modifications can be made to the embodiments disclosed herein, without departure from the invention, the scope of which is defined in the appended claims.

1. Display tray apparatus for displaying multimedia content to customers of food service establishments, comprising:
a) a food serving tray comprising a rigid plate portion having a top surface shaped for carrying food; and
b) display apparatus embedded in the plate portion, the display apparatus comprising a user viewable display screen, a network interface for communicating with a remote server containing multimedia content, and a display controller for controlling the display screen and the network interface.

2. The apparatus of claim 1, wherein the food serving tray further comprises a raised edge portion surrounding the plate portion.

3. The apparatus of claim 1, wherein the plate portion includes a cut-out shaped for receiving the display screen.

4. The apparatus of claim 3, wherein the plate portion has a bottom surface having at least one recess therein shaped for receiving components of the display apparatus.

5. The apparatus of claim 1, wherein the food serving tray comprises a top cover sheet for covering the plate portion and the display screen, the cover sheet having a transparent portion located to overlay the display screen.

6. The apparatus of claim 4, wherein the food serving tray comprises a bottom cover sheet for covering the bottom surface of the plate portion and protecting the components of the display apparatus.

7. The apparatus of claim 1, wherein the display apparatus comprises a user input module operatively coupled to the display controller the user input module enabling a user to interact with the display screen and the remote server.

8. The apparatus of claim 1, wherein the display controller comprises a central processing unit (CPU), memory, display panel controller, real-time clock (RTC), a rechargeable battery, and a charging controller.

9. The apparatus of claim 1, wherein the network interface comprises a wireless communication module for communicating wirelessly with the remote server.

10. The apparatus of claim 7, wherein the user input module comprises a plurality of user operable buttons.

11. The apparatus of claim 7, wherein the use input module comprises a directional joystick.

12. The apparatus of claim 8, wherein the food serving tray comprises a recharging rail extending from an outside surface of the raised edge portion, the recharging rail being electrically connected to the display apparatus.

13. The apparatus of claim 12, wherein the food serving tray further comprises an I/O port extending outwardly from the outside surface of the raised edge portion, the I/O port being electrically connected to the display apparatus.

14. A system for delivery of multimedia content to customers of food service establishments, comprising:
a) a multimedia content server comprising a computer server having multimedia content stored in a content database and a server network interface;
b) a communications network connected to the content server and the server network interface; and
c) a plurality of display trays comprising a food serving tray having a rigid plate portion and display apparatus embedded in the plate portion wherein the display apparatus comprises a display screen a display controller, and a client network interface capable of connecting to the communications network and receiving multimedia content from the content server.

15. The system of claim 14, wherein the communications network, the server network interface and the client network interface are wireless.

16. The system of claim 14, wherein the display tray further comprises an I/O port, the I/O port being electrically connected to the display controller, allowing the display tray to be in communication with a user device and to transfer multimedia content to it.

17. The system of claim 15, wherein each of the plurality of display trays comprises a food serving tray having a rigid plate portion and a raised edge portion surrounding the plate portion, the raised edge portion having an outwardly extending top flange.

18. The system of claim 17, wherein the food serving tray further comprises a recharging rail extending outwardly from an outside surface of the raised edge portion, the recharging rail being electrically connected to the display controller.

19. The system of claim 18, wherein the system further comprises at least one tray rack for recharging the plurality of display trays, the tray rack comprising:
a) a frame having at least one frame section, the frame section comprising a first horizontally extending support member, a second horizontally extending support member spaced therefrom, and vertical members extending between the first support member and the second support member;
b) the first support member having an upper surface with a plurality of longitudinally spaced, transversely extending first tray slots therein, and the second support member having a bottom surface with a plurality of longitudinally spaced, transversely extending second tray slots therein, the tray slots in the first and second support members being located so as to form a series of vertically aligned pairs of trays slots, the slots being shaped so as to receive the top flange of the raised edge portion of one of the display trays, the support members being spaced apart so that one of the display trays may be placed on edge and slid into each of the aligned pairs of tray slots; and
c) a plurality of transversely extending charging rails affixed to the support members adjacent the tray slots, the charging rails being located to contact the recharging rails when the display trays are slid into the aligned pairs of tray slots.

20. The system of claim 19, wherein the tray rack comprises a rack network interface, connectable to the communications network, allowing the tray rack to be in communication with the content server.

21. The system of claim 19, wherein the tray rack comprises a plurality of rack port connectors, wherein the rack port connectors are shaped to connect to I/O port connectors of the display trays so that multimedia content can be communicated to the display trays.

22. A method for delivering multimedia content to customers of food service establishments, comprising the steps of:
a) providing multimedia content, comprising one or more programs containing audio, still images, video, text, and computer instructions in any combination, on a content server, the server comprising a computer server having a multimedia content database and a server network interface connected to a wireless network;
b) providing a plurality of display trays to customers, each of the display trays comprising a food serving tray having a rigid plate portion, and display apparatus embedded in the plate portion, the display apparatus comprising a user viewable display screen, a display controller, and a client network interface connected to the wireless network;
c) transferring the multimedia content from the server, through the network to the display trays; and
d) displaying the multimedia content to the customer through the display screen.

23. The method of claim 22, comprising the further steps of:
a) queueing the multimedia content to be delivered as current multimedia content to customers during a pre-selected time period;
b) transferring the current multimedia content from the content server through the wireless network to the display controller;
c) storing the current multimedia content to a memory in the display controller;
d) displaying the current multimedia content to the customer through the display screen; and
e) receiving input from the user and responding thereto, wherein responding to user input includes retrieving more content from the content server.

24. The method of claim 23, further comprising the step of transferring the multimedia content from the display controller to a user device.

25. The method of claim 23, wherein the user input includes purchase information.

26. The apparatus of claim 7, wherein the user input module comprises a touch sensitive portion of the display screen.

27. The system of claim 14, wherein a first display controller of a first display tray is configured to publish a list of shareable multimedia content to the content server, and a second display controller of a second display tray is configured to access the list of shareable multimedia content and to request the content from the content server, the content server being configured to retrieve the requested content from the first display controller and to communicate the requested content to the second display controller.

28. The system of claim 14, wherein the display controller is configured to transfer the multimedia content to a network account.

29. The system of claim 14, wherein the multimedia content comprises an on-line or networked game, the game being playable by a first player operating a first display controller of a first display tray against at least one opponent operating a second display controller of a second display tray, the first and second display controllers being in communication with the content server.
